(19) United States
(12) Patent Application Publication
(10) Pub. No.: US 2025/0173678 A1
(43) Pub. Date: May 29, 2025

(54) Systems and Methods for Facilitating Vegetation, Construction, or Facilities Management

(71) Applicant: Wormhole Information Technology Systems LLC, Austin, TX (US)

(72) Inventors: Guillaume Riviere, Lake Clarke Shores, FL (US); Anthony Victor Mangione, III, Coral Springs, FL (US); Herbert Hughes, Fort Worth, TX (US)

(21) Appl. No.: 18/520,286

(22) Filed: Nov. 27, 2023

(51) Int. Cl. G06Q 10/10

(52) U.S. Cl. CPC G06Q 10/103

(57) ABSTRACT

Systems, methods, and devices are contemplated for autonomously facilitating or improving management agriculture, construction, or facility operations by a server system. A device is used to gather and report information about a location related to the operation, which is processed to identify operational issues to be resolved. A geographic feature of the operation location is used to select a source of information regarding obligations, requirements, or rights associated with the location or the operation. The source of information is accessed and contents analyzed to identify a person with authority related to the issue, and the person is contacted regarding the issue.

### FIELD OF THE INVENTION

The field of the invention is system management with respect to relevant authority.

### BACKGROUND

The following description includes information that may be useful in understanding the present invention. It is not an admission that any of the information provided herein is prior art or relevant to the presently claimed invention, or that any publication specifically or implicitly referenced is prior art.

As compilation and access to vast and diverse bodies of data have increased, autonomous processes have been used to leverage such data to improve performance of tasks ranging from mundane to complex. For example, U.S. Pat. No. 11,394,462 to Graham et al. teaches intuitive and semi-automated methods to leverage crowdsourced data to improve workplace and building management, for example to match building or workplace conditions to user feedback or requests. While such systems may reduce the disparity between user/employee expectation/desire and workplace conditions, they do not actively seek, identify, and resolve problems related to managing a facility by engaging with people with competent authority over the problem.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for systems and methods of to identify problems related to managing a facility or project, identify persons with authority over the problem, and engage with such persons to resolve the problem in an autonomous fashion.

### SUMMARY OF THE INVENTION

The inventive concepts herein contemplate systems, methods, and devices for facilitating system or operation management, for example vegetation, construction, or facilities management. A server system autonomously addresses issues. The server system autonomously receives data from at least one device engaged to obtain information regarding a location. The system autonomously processes the received data to identify an issue to address for resolution. A geographic characterization of the location is autonomously used to select an external data source with one or more of rights, obligations, or requirements related to the region (e.g., compliance, public health, easement, lease, ownership information, etc. related to the region). At least one selected data source is autonomously accessed to identify one or more people with apparent authority related or relevant to the issue. A contact information is autonomously derived for the first person and used to contact one or more of the people about the issue.

Devices engaged to obtain information about the location can include drone(s), or a cell phone carried by a person tasked to perform work at the location. The server system can be used to normalize and parameterize information from a combination of public and private data sources, with the normalized and parameterized information then used to select one or more of the external data sources. In some embodiments the geographic characterization is a property line, but can also be a politically designated region, a street, or other address designated region or combinations thereof.

The issues addressed include malfunction(s) of an item of equipment. For example the location of the item of equipment can be derived from the external data source and used to inform an apparent, suspected, reported, or verified malfunction. Likewise an age, a manufacturer or operator, or a warranty information, or combinations thereof, of the item of equipment can be derived from the external data source.

Various resources, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a diagram of a workflow of the inventive subject matter.

### DETAILED DESCRIPTION

Systems, methods, and devices leveraging autonomous functionality for facilitating system or operation management, for example vegetation, construction, or facilities management, are contemplated.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

A server system is contemplated to autonomously address issues, problems, or action items in the context of an enterprise or project management or operation. The server system autonomously receives data from one or more devices to obtain information about a location. Such devices include drones (e.g., aerial, terrestrial, or marine based; autonomous, semi-autonomous, or user piloted, etc.), smart devices (e.g, smart phone, smart car, etc.), or other devices incorporated camera or sensors, for example in control of a user at a project site or enterprise. “Autonomous” is defined as commonly known in the art, and otherwise includes devices operating on their own (e.g., self-directed navigation, self-directed objectives, self-directed tasks, etc.), devices receiving guideline directives and acting upon them (e.g., systems or users set broad objectives or desired outcomes, systems or users define and assign individual tasks, etc.), or devices performing autonomous functions while under user or system active control (e.g., user navigates while device autonomously pilots, etc.).

The system autonomously processes the received data to identify an issue to address for resolution. Issues can include regulatory requirements to advance development or completion of a project, or to maintain or improve operation of a project or enterprise, policy requirements or objectives of an enterprise, tasks in a workflow to advance or complete projects or to maintain operation of an enterprise or project, or tasks in a workflow to develop or propose new projects or operations of an enterprise or to meet new goals or objectives.

A geographic characterization of the location is autonomously used to select an external data source with one or more of rights, obligations, or requirements related to the region (e.g., compliance, public health, easement, lease, ownership information, etc. related to the region or location). At least one selected data source is autonomously accessed to identify one or more people or institutions with apparent authority related or relevant to the issue (e.g., administrative authority, legal authority, advisory authority, financial authority, expert authority, etc.). A contact information is autonomously derived for the person(s) or institution(s) and used to contact one or more of the person(s) or institution(s) about the issue.

In some embodiments the server system can be used to normalize and parameterize information from a combination of public and private data sources, for example data related to the enterprise, operation of the enterprise, or projects, related to the issues, or related to the geographic location or characterization thereof, etc. The normalized and parameterized information is then used to select or inform the selection of one or more external data sources. In some embodiments the geographic characterization is a property line, but can also be a politically designated region, physical condition of a property, a street, or other address designated region, or combinations thereof.

The issues addressed can include malfunction(s) of an item of equipment. For example the location of the item of equipment can be derived from the external data source and used to inform an apparent, expected, suspected, reported, or verified malfunction. Likewise an age, a manufacturer or operator, or a warranty information, or combinations thereof, of the item of equipment can be derived from the external data source.

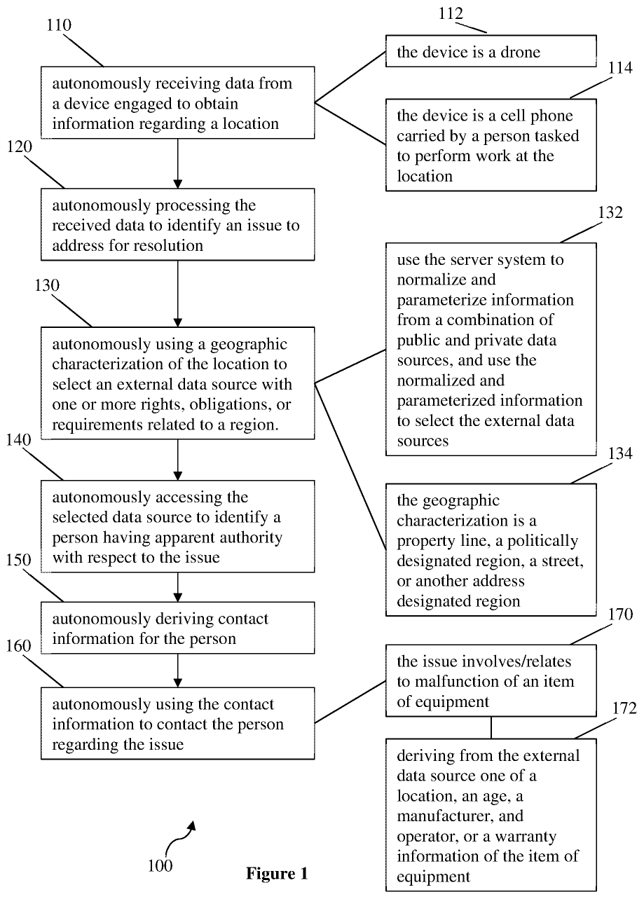

FIG. 1 depicts diagram 100 of a workflow of methods and systems of the inventive subject matter. Diagram 100 depicts steps 110, 120, 130, 140, and 150, as well as optional step 160, which proceed in sequential order.

Step 110, autonomously receiving data from a device engaged to obtain information regarding a location, can further include optional features 112, where the device is a drone, or 114, where the device is a cell phone, either alone or in combination.

Step 130, autonomously using a geographic characterization of the location to select an external data source with one or more rights, obligations, or requirements related to a region, can further include optional features 132, to normalize and parameterize data and select external data sources or 134, where the geographic characterization is a property line, political region, street, or other address, either alone or in combination.

Optional step 170, where the issue relates to malfunction of an item, follows step 160 and can further include optional feature 172 to derive from the external data source a location, an age, a manufacturer, and operator, or a warranty information of the item of equipment.

While the following description is drawn to various alternative configurations are also deemed suitable and may employ various computing devices including servers, interfaces, systems, databases, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclose apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method for facilitating vegetation, construction, or facilities management, comprising utilizing a server system to autonomously accomplish the following:
receive data from at least one devices engaged to obtain information regarding a location;
process the received data to identify an issue to address for resolution;
use a geographic characterization of the location to select at least one external data source having at least one of compliance, public health, easement, lease, and ownership information related to the region;
access the at least one selected data source to identify at least a first person having apparent authority with respect to the issue;
derive contact information for the first person; and
use the contact information to contact the first person regarding the issue.

2. The method of claim 1, wherein at least one of the devices engaged to obtain information regarding the location comprises a drone.

3. The method of claim 1, wherein at least one of the devices engaged to obtain information regarding the location comprises a cell phone carried by a person tasked to perform work at the location.

4. The method of claim 1, further comprising utilizing the server system to normalize and parameterize information from a combination of public and private data sources, and use the normalized and parameterized information to select the at least one external data sources.

5. The method of claim 1, wherein the geographic characterization comprises identifying a property line.

6. The method of claim 1, wherein the geographic characterization comprises identifying a politically designated region.

7. The method of claim 1, wherein the geographic characterization comprises identifying a street or other address designated region.

8. The method of claim 1, wherein the issue involves malfunction of an item of equipment.

9. The method of claim 8, further comprising deriving from the at least one external data source a location of the item of equipment.

10. The method of claim 8, further comprising deriving from the at least one external data source an age of the item of equipment.

11. The method of claim 8, further comprising deriving from the at least one external data source a manufacturer or operator of the item of equipment.

12. The method of claim 8, further comprising deriving from the at least one external data source warranty information regarding the item of equipment.
